(19) United States
(12) Patent Application Publication
(10) Pub. No.: US 2018/0021859 A1
(43) Pub. Date: Jan. 25, 2018

(54) DEVICE FOR RETAINING DUST CREATED BY A DRILLING OPERATION, AND METHOD FOR DRILLING A WALL USING SAID RETAINING DEVICE

(71) Applicant: GERFLOR, Villeurbanne (FR)

(72) Inventors: Alain Rivat, Les Sauvages (FR); Olivier Ceysson, Bollene (FR); Sébastien Metayer, Saint Symphorien De Lay (FR)

(21) Appl. No.: 15/542,725

(22) PCT Filed: Jan. 14, 2016
(86) PCT No.: PCT/FR2016/050068

§ 371 Date: Jul. 11, 2017

(30) Foreign Application Priority Data
Jan. 16, 2015 (FR) 1550340

(51) Int. Cl. B23B 47/34

(52) U.S. Cl. CPC B23B 47/34; B23B 45/00

(57) ABSTRACT

The invention relates to a device for retaining dust created by a drilling operation, comprising a closed envelope defining a space for receiving said dust, said envelope comprising a rear face for applying to a wall to be drilled, and a front opposing face through which a drill bit penetrates for the actual drilling operation.

The envelope contains a gel suitable for being mixed, by the rotation of the drill bit, with the dust from the drilling operation.

### ART

This invention relates to the construction field and in particular to the drilling of any material with a hand tool, such as a drill equipped with a drill bit.

This invention relates more particularly to a device for retaining dust residues or any other debris created by a drilling operation, and to a method for drilling a wall using said retention device.

The invention finds an advantageous but non-limiting application in the retention of dust created by a drilling operation of any surface and more particularly of an asbestos material. Without departing from the scope of the invention, within the rest of the description the term “wall” may be replaced by the term “surface” to designate the location whereupon the drilling operation is to be performed.

### PRIOR ART

A prior art device is known for retaining dust created by a drilling operation, in the form of a transparent plastic capsule comprising an envelope defining a space for receiving said dust.

More precisely, said capsule comprises a rear face for applying to a wall to be drilled, and a front opposing face through which an abutting drill bit penetrates for the actual drilling operation.

In order to perform the drilling operation, the drill bit, driven in rotation, pierces and successively penetrates the front and rear faces of the capsule to then pierce the wall. The capsule remains pressed against the wall, and the dust created by the drilling operation, which is generally evacuated along the drill bit, is trapped within the space of said capsule.

Advantageously, the rear wall of this type of capsule comprises adhesive means for holding said capsule against the wall to be drilled thereby liberating the hands of the user performing the drilling operation.

This type of retention capsule produces coarse results that are more satisfactory for small drilling jobs. Indeed, the seal between the capsule and the wall to be drilled is not optimal such that dust leakages occur during drilling. Moreover, the seal between the drill bit and the pierced capsule is also not optimal and also leads to the leaking of dust.

Thus, this type of capsule is acceptable for small do-it-yourself jobs. However, due to the residual leaks, this type of capsule is not suitable for piercing materials based upon toxic or carcinogenic products, such as asbestos for example.

### DISCLOSURE OF THE INVENTION

Thus, the object of the invention is to provide a device for retaining dust created by a drilling operation that makes it possible to retain said dust in an optimal manner and without leakage.

Another object of the invention is to provide such a dust retention device that makes it possible to make holes in asbestos products in a safe, secure and rapid manner.

In order to solve the aforementioned problems, a device for retaining dust created by a drilling operation has been developed, comprising a closed envelope, preferably transparent to light and defining a space for receiving said dust. The envelope comprises a rear face for applying to a wall to be drilled, and a front face opposite said rear face, through which a drill bit penetrates for the actual drilling operation.

According to the invention, the envelope contains a gel, preferably transparent to light, and suitable for being mixed, by the rotation of the drill bit, with the dust from the drilling operation.

The term “gel” is understood to mean a product, mainly consisting of liquid, but behaving as a solid, i.e., that does not flow when in a stable state.

In this way, in order to perform the drilling operation, the retention device is positioned in such a way that the rear face thereof is applied to the wall to be drilled. The fact that the capsule and the gel are advantageously transparent facilitates the positioning and centering of the retention device with respect to the hole to be made. A drill bit then abuts against the front face and starts the drilling operation by rotation. Thus, the drill bit pierces and penetrates the front face of the envelope of the device, then penetrates the gel and drives it, at least in part, into rotation, and ultimately the drill bit pierces and penetrates the rear face of the envelope in order to drill into the wall itself.

The dust created by the drilling operation then returns along the drill bit and, without leaking, is trapped within the gel by mixing therewith. The seal between the retention device and the drill bit is optimal. The device according to the invention thus makes it possible to securely drill into an asbestos material, in a safe and rapid manner.

To facilitate the use of the retention device according to the invention, it comprises an adhesive layer arranged on the rear face thereof to enable the attachment of said device to the wall to be drilled.

In order to further improve the seal between the wall to be drilled and the retention device according to the invention, the rear face of the envelope comprises an opening that is adapted to the dimensions of the hole to be made, and sealed by means of a peelable seal, preferably made of a material that is transparent to light.

In this way, the seal is removed before the retention device is positioned against the wall to be drilled. Once removed the seal reveals an opening, for example circular, in the rear face of the envelope. In order to perform the drilling, the rear face of the envelope is applied to the wall to be drilled such that the opening in the rear face coincides and communicates with the hole to be made. Thus, the drilling to be performed is in direct communication with the internal space of the device and the gel, in such a way that, during drilling, the seal between the retention device and the wall to be drilled is optimal. The risk of dust leakage is eliminated.

In a more advantageous manner, after removing the seal, the gel comes directly into contact with the wall to be drilled when the device is applied to said wall, in such a way that the seal is increased.

In a specific embodiment of the retention device according to the invention, the peelable seal is arranged on the adhesive layer. The adhesive layer comprises an opening corresponding to the opening of the rear face, and the face of the adhesive layer in contact with the envelope comprises a greater adhesive force than the face in contact with the seal, in such a way as to remain on the rear face of the envelope after removal of the peelable seal and to allow the attachment of said device to the wall to be drilled.

Preferably, the retention device comprises means for centering the capsule with respect to the hole to be made.

Preferably, the retention device comprises means for guiding the drill bit.

In a specific embodiment, the centering means and guiding means are in the form of a recess formed within the front face of the envelope, suitable on the one hand for receiving and guiding a drill bit and, on the other hand, for allowing the centering of the device by aligning the recess with the hole to be made.

In a specific embodiment, the envelope is tapered and advantageously comprises an annular peripheral bead formed on the side of the front face in such a way as to avoid, during drilling, the direct raising of dust. Indeed, the rounded shape of the bead makes it possible to direct the dust towards the center of the space of the retention device, and thus avoid any risks of leaking.

According to a particular embodiment, the device according to the invention comprises a washer arranged transversely within the envelope in order to partition the gel and prevent it from spreading out of the space when the drill bit is removed.

According to another embodiment, the envelope is divided into two spaces by a membrane arranged transversely and through which a drill bit penetrates during the drilling operation, a first space on the side of the rear face contains the gel and is intended for receiving the dust and a second space containing air such that the gel can spread therein when the drill bit is removed at the end of the drilling operation.

Preferably, a foam pad is arranged on the rear face of the device in order to guarantee sealing between the wall to be drilled and the device when it is positioned against the wall.

The invention also aims to provide a method for the drilling of a wall by means of a rotating drill bit. According to the invention, the method is remarkable in that it consists in:
the positioning against the wall to be drilled of a device having a closed envelope defining a space enclosing a gel and comprising a rear face applied to said wall to be drilled and a front face opposite the rear face,
performing the drilling operation in such a way that the drill bit pierces and penetrates the front face of the envelope of the device, then penetrates the gel, and pierces and penetrates the rear face of the envelope in order to drill into the wall itself.

Thus, the dust created by the drilling operation and evacuated along the drill, is mixed with the gel.

In order to drill a through-hole in the wall, the method comprises, prior to the step of performing the drilling, a step consisting in positioning against an opposite face of the wall to be drilled and facing the first device, a second device having a closed envelope defining a space enclosing a gel and comprising a rear face applied to said wall to be drilled and a front face opposite the rear face such that, after penetrating the wall, the drill bit pierces and penetrates the rear face of the envelope of the second device ending the travel thereof within the gel of the envelope of the second device.

Thus, the dust created by the drilling operation, evacuated along the drill bit and through the through-hole, is mixed with the gel within the first and second devices.

It should be noted that the second device used in the method for drilling a through-hole in a wall incorporates all of the characteristics of the device according to the invention. Alternatively, the front face of this second device may be designed to prevent the drill from penetrating it. In fact, during the drilling operation for a through-hole in a wall, the rear face of this second device is penetrated by the drill bit but, nevertheless, it is not desirable for the drill bit to end its travel outside the envelope of said second device.

In a preferred embodiment, in order to facilitate the positioning of the second device on the drilling axis, the rear face of the second device has a greater surface area than the surface area of the rear face of the first device. Preferably, the rear face of the second device is circular and has a diameter of between 10 and 20 cm.

### BRIEF DESCRIPTION OF FIGURES

Further characteristics and advantages of the invention will become apparent from the description provided below, which is for reference only and is in no way restrictive, with reference to the accompanying figures, wherein:

FIG. 1 is a schematic view of a first embodiment, seen from the side, of a retention device according to the invention;

FIG. 2 is a schematic view of a second embodiment of the device according to the invention;

FIG. 3 depicts a washer arranged inside the device according to the invention;

FIG. 4 is a schematic view of a third embodiment of the device according to the invention.

### DETAILED DISCLOSURE OF THE INVENTION

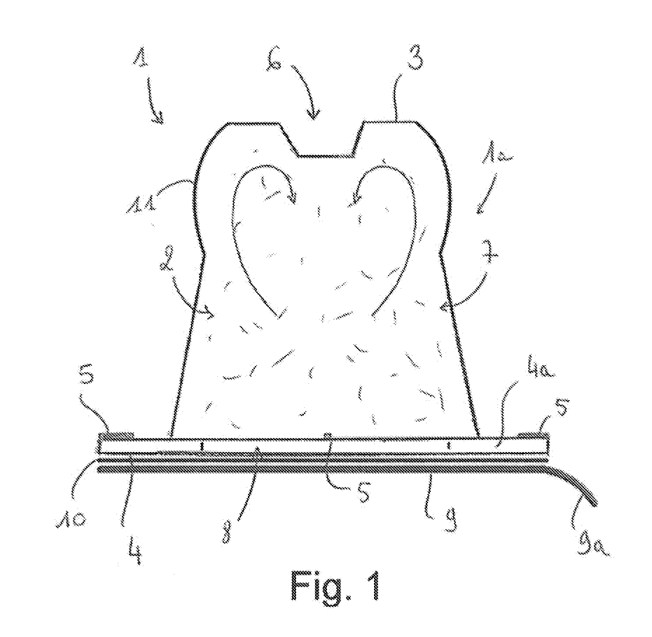

The invention relates, with reference to FIGS. 1 to 4, to a device (1) for retaining dust created by a drilling operation.

More precisely, the retention device (1) is in the form of a plastic capsule (1a), preferably transparent to light, and advantageously of a generally tapered shape.

The capsule (1a) comprises a closed envelope such as to define an internal space (2) for receiving dust. The capsule (1a) comprises a circular front face (3) and a rear face (4), that is also circular, and that is formed by the large tapered base.

The device (1) according to the invention is used to recover the dust created by a drilling operation. For this purpose, the drilling is performed through said capsule (1a).

The rear face (4) comprises an annular bearing flange (4a) and is intended to be applied to a wall to be drilled. This flange (4a) advantageously comprises a centering cross, that is to say four notches or, more generally, four visual indicators (5) arranged on the periphery of said flange (4a) and distributed regularly around said flange (4a). This centering cross makes it possible to visualize the center of the rear face (4) and to correctly position said face with respect to the hole to be made.

The front face (3) of the capsule (1a) comprises a recess (6), that is preferably circular or tapered, centered and adapted on the one hand to receive and guide a drill bit and, on the other hand, to allow the device (1) to be centered by aligning the recess (6) with the hole to be made. The recess (6) is also, in fact, centered with respect to the centering cross of the flange (4a).

In order to recover the dust in an optimal way, the capsule (1a) contains a product in the form of a gel (7), such as for example an ultrasound gel, a water based gel, a glycol-polyacrylate gel and sheath based gel. The gel (7) may be of any suitable type, the essential aspect lies in the fact that it is suitable for mixing with the dust created during a drilling operation. In order to withstand the high drill bit temperatures during the drilling operation the gel (7) advantageously contains either silicone or grease.

The gel (7) is a non-Newtonian fluid, mainly comprising a fluid that behaves as a solid, i.e., that does not flow when in a stable state.

The rear face (4) of the capsule (1a) comprises a circular opening (8), that is centered and adapted to the dimensions of the hole to be made. The opening (8) is notably larger than the hole to be made, and is sealed by a peelable seal (9), preferably of a material that is transparent to light.

The seal (9) comprises a peripheral tab (9a) in order to facilitate the removal thereof. It is held in position on the rear face (4) of the capsule (1a) by means of an adhesive layer (10), comprising an opening in correspondence with the opening (8) of the rear face (4), wherein the force of adhesion to the side of the capsule (1a) is greater than the force of adhesion to the side of the seal (9).

Thus, when the seal (9) is peeled back and removed, the adhesive layer (10) remains on the rear face (4) of the capsule (1a) and allows for the attachment and holding of the capsule (1a) against the wall to be drilled.

In this way, to implement the drilling operation, the seal (9) is removed by pulling on the tab (9a), and the capsule (1a) is positioned in such a way that the rear face (4) of its envelope is applied to the wall to be drilled. The seal (9) is centered in relation to the hole to be made by means of the centering cross and/or the recess (6) in the front face (3). The adhesive layer (10) holds the capsule (1a) against the wall to be drilled.

The drill bit then enters into the centering and guiding recess (6), abutting against the front face (3) and the drilling operation commences. Thus, the drill bit pierces and penetrates the front face (3) of the envelope of the capsule (1a), then penetrates the gel (7) and drives it, at least in part, into rotation, and ultimately the drill bit pierces and penetrates the rear face (4) through the opening (8) in order to drill into the wall itself.

When drilling a through-hole in the wall, it is advisable, prior to performing the drilling, to position against an opposite face of the wall to be drilled and facing the first device (1), a second identical device (1) such that after penetrating the wall the drill bit pierces and penetrates the rear face (4) of the envelope of the second device ending the travel thereof within the gel of the envelope of the second device.

Thus, the dust created by the drilling operation, evacuated along the drill bit and through the through-hole, is mixed with the gel (7) within the first and second devices.

The seal between the capsule (1a) and the wall to be drilled, as well as between the capsule (1a) and the drill bit, is optimal. The dust created by the drilling operation then returns along the drill bit and, without leaking, is trapped within the gel (7) by mixing therewith.

In an advantageous manner, the envelope comprises an annular peripheral bead (11) formed on the side of the front face (3) in such a way as to avoid, during drilling, the direct raising of dust. Indeed, the rounded shape of the bead (11) makes it possible to direct the dust towards the center of the space (2) of the capsule (1a), and thus avoid any risks of leaking.

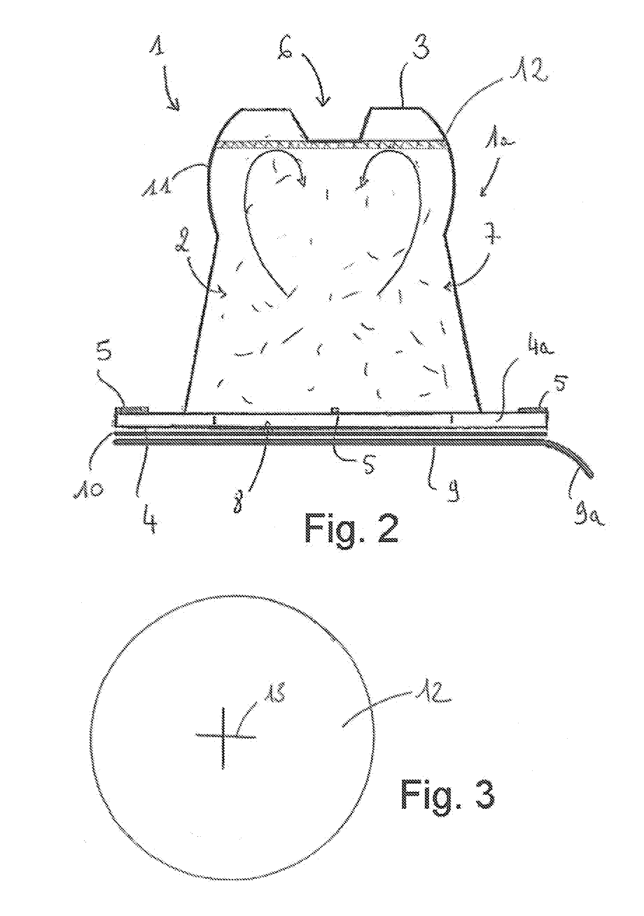

In an advantageous way, and with reference to FIG. 2, the retention device (1) comprises a washer (12) transversely arranged inside the envelope, and preferably in contact with the front face (3) of the device. The washer is for example made of polyurethane or silicone and makes it possible to guide the drill bit whilst preventing the gel from spreading out of the space (2) when the drill bit is removed.

With reference to FIG. 3, the washer advantageously comprises a centering cross (13) formed for example by four notches arranged within the thickness of the washer (12). This cross (13) makes it possible to create a temporary opening that allows for the passage of the drill bit and closes upon itself when the drill bit is removed at the end of the drilling operation.

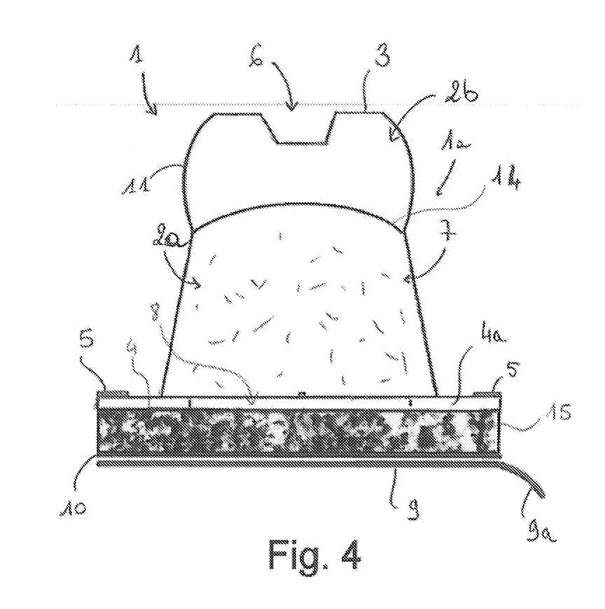

In another embodiment, and with reference to FIG. 4, the envelope is divided into two spaces (2a, 2b) by a membrane (14) arranged transversely and through which a drill bit penetrates during the drilling operation. A first space (2a) on the side of the rear face contains the gel (7) and is intended to receive the dust. A second space (2b) contains air, and is big enough for a small amount of gel to spread when the drill bit is removed at the end of the drilling operation. In this way, the gel (7) that is eventually carried away by the movement of the drill, spreads into the second space (2b), thus avoiding the release outside the envelope of dust trapped within the gel.

Again, with reference to FIG. 4, a foam pad (15) can be advantageously arranged on the rear face (4), between the opening (8) and the peelable seal (9), in order to close said opening (8). This foam pad (15) makes it possible to improve the seal of the connection between the wall to be drilled and the device when it is positioned against the wall. For this purpose, the foam pad (15) is flexible enough to correct any evenness or roughness defects of said wall. The foam pad (15) also makes it possible to ensure sealing during a drilling operation within a groove of a width that is less than the surface of the rear face, particularly with step drilling operations.

The foam pad (15) is advantageously made of polyethylene or polypropylene foam of a low density. Alternatively, the foam pad (15) is not secured to the device, in such a way that it can be arranged independently of the device against the wall to be drilled, the device being subsequently arranged on the foam pad for the drilling operation. Advantageously, the foam pad can have an adhesive layer (10).

In an advantageous way, the rear face of the device has a concave or convex plane such as to facilitate the arrangement thereof on undulating walls. Such walls are for example pipes or corrugated roof panels. Advantageously, the rear face is also flexible enough to be able to be deformed and improve sealing when the device is arranged on an undulating wall wherein the curvature thereof differs slightly from the curvature of the rear face of the device.

In an advantageous manner, the distance between the front face (3) and the rear face (4) of the device is less than or equal to 50 mm, preferably less than or equal to 35 mm. In this way, most drilling operations can be performed with conventional drills without the risk of the drill chuck used coming into contact or even penetrating the envelope of the device. Conventional drilling operations notably consist in making a hole that is intended to receive a wall plug from 20 to 50 mm in length. These operations are usually performed using a drill less than 110 mm long.

Thus, it results from the foregoing that the invention proposes a dust retention device (1) for performing drilling operations into an asbestos material, in a safe, secure, simple and rapid manner, both with horizontal and vertical walls, without emitting asbestos fibers. This capsule (1a) then makes it possible to eliminate all onerous safety measures, such as for example wearing a waterproof overall and a respiratory mask.

When the hole is made, the asbestos waste is trapped within the gel (7) of the capsule (1a), and can easily be treated as asbestos waste.

1. A device for retaining dust created by a drilling operation, comprising a closed envelope defining a space for receiving said dust, said envelope comprising a rear face for applying to a wall to be drilled, and a front face opposite the rear face, through which a drill bit penetrates for the drilling operation, said envelope containing a gel suitable for being mixed, by the rotation of the drill bit, with the dust from the drilling operation.

2. The device for retaining dust according to claim 1, wherein the envelope and the gel are transparent to light.

3. The device for retaining dust according to claim 1, comprises comprising an adhesive layer arranged on the rear face thereof to enable the attachment of said device to the wall to be drilled.

4. The device for retaining dust according to claim 1, wherein the rear face of the envelope comprises an opening, adapted to the dimensions of a hole to be made, and sealed by means of a peelable seal.

5. The device for retaining dust according to claim 4, wherein the seal is transparent to light.

6. The device for retaining dust according to claim 4, wherein the peelable seal is arranged on the adhesive layer, said adhesive layer comprising an opening corresponding to the opening of the rear face, and a face of the adhesive layer in contact with the envelope comprises a greater adhesive force than a face in contact with the seal, in such a way as to remain on the rear face of the envelope after removal of the peelable seal and to allow the attachment of said device to the wall to be drilled.

7. The device for retaining dust according to claim 1, comprising centering means in relation to the hole to be made.

8. The device for retaining dust according to claim 7, wherein the centering means are in the form of a recess formed within the front face of the envelope, suitable for receiving and centering the device by aligning the recess with the hole to be made.

9. The device for retaining dust according to claim 1, comprising means for guiding the drill bit.

10. The device for retaining dust according to claim 9, wherein the guiding means are in the form of a recess formed within the front face of the envelope, suitable for receiving and guiding the drill bit.

11. The device for retaining dust according to claim 1, wherein the envelope is tapered and comprises an annular peripheral bead arranged on the side of the front face.

12. The device for retaining dust according to claim 1, comprising a washer arranged transversely within the envelope in order to partition the gel and prevent it from spreading out of the space when the drill bit is removed.

13. The device for retaining dust according to claim 1, wherein the envelope is divided into two spaces by a membrane arranged transversely and through which a drill bit penetrates during the drilling operation, a first space on the side of the rear face contains the gel and is intended for receiving the dust and a second space containing air such that the gel can spread therein when the drill bit is removed at the end of the drilling operation.

14. The device for retaining dust according to claim 1, wherein a foam pad is arranged on the rear face in order to guarantee sealing between the wall to be drilled and the device when it is positioned against the wall.

15. A method for the drilling of a wall by means of a drill bit in rotation comprising the steps of:
positioning against the wall to be drilled of a device having a closed envelope defining a space enclosing a gel and comprising a rear face applied to said wall to be drilled and a front face opposite the rear face;
performing the drilling operation in such a way that the drill bit pierces and penetrates the front face of the envelope of the device, then penetrates the gel, and pierces and penetrates the rear face of the envelope in order to drill into the wall.

16. The method according to claim 15, comprising, prior to the step of performing the drilling, a step comprising positioning against an opposite face of the wall to be drilled and facing a first device, a second device having a closed envelope defining a space enclosing a gel and comprising a rear face applied to said wall to be drilled and a front face opposite the rear face such that after penetrating the wall, the drill bit pierces and penetrates the rear face of the envelope of the second device ending the travel thereof within the gel of the envelope of the second device.
